(19) United States
(12) Patent Application Publication
(10) Pub. No.: US 2021/0348441 A1
(43) Pub. Date: Nov. 11, 2021

(54) PLAYPEN DOOR

(71) Applicant: Zhongshan Ekar Uping Houseware Co., Ltd., Zhongshan, Guangdong (CN)

(72) Inventors: Jianghua HE, Zhongshan, Guangdong (CN); Guozhu FENG, Zhongshan, Guangdong (CN); Xinliang OUYANG, Zhongshan, Guangdong (CN)

(21) Appl. No.: 16/959,272

(22) PCT Filed: May 21, 2020
(86) PCT No.: PCT/CN2020/091439

§ 371 Date: Jun. 30, 2020

(30) Foreign Application Priority Data
May 11, 2020 (CN) 202020770018.0

(51) Int. Cl. E06B 9/04; E05B 65/00

(52) U.S. Cl. CPC E06B 9/04; E06B 2009/002; E05B 65/0007

(57) ABSTRACT

A playpen door, including: a door frame, a door body movably mounted on the door frame and having an open state and a closed state, and a detection assembly mounted on the door frame or the door body. The detection assembly includes a control panel, a control switch and a pressing module. The control switch is arranged on the control panel, the pressing module is configured to be movable with respect to the control switch to trigger the control switch, and the pressing module is driven to move with respect to the control switch when the door body is switched between the open state and the closed state.

### FIELD

The disclosure relates to the technical field of a playpen device and in particular to a playpen door.

### BACKGROUND

When a caregiver is unable to always look after an infant or pet for various reasons, it is necessary to provide a safe environment for the infant or pet to play. In this case, people usually use a playpen to enclose a safe area. The playpen is generally provided with a door for easy entry and exit. The infant can open the playpen door after he/she grows up a little, or the pet can open the playpen door after a long period of observation and learning. The caregiver may be unaware of this situation in time. As a result, the infant or pet goes out of the playpen without the caregiver's knowledge, which is unable to realize the infant/pet-caring effect.

### SUMMARY

To at least solve one of the technical problems in the prior art, there is provided a playpen door according to the disclosure which can detect an open or closed state of the door body in real time.

In an aspect of the disclosure, a playpen door is provided, including: a door frame; a door body movably mounted on the door frame and having an open state and a closed state; and a detection assembly mounted on the door frame or the door body. The detection assembly includes a control panel, a control switch and a pressing module, the control switch is arranged on the control panel, the pressing module is configured to be movable with respect to the control switch to trigger the control switch, and the pressing module is driven to move with respect to the control switch when the door body is switched between the open state and the closed state.

In some embodiments of the disclosure, the detection assembly includes a mounting shell having a mounting chamber; the mounting shell is mounted on the door body, the control panel is located in the mounting chamber, the pressing module is slidably mounted in the mounting shell, one end of the pressing module is located in the mounting chamber and the other end thereof is located outside the mounting chamber.

In some embodiments of the disclosure, the pressing module includes a slide bar and a spring, the slide bar is slidably mounted in the mounting shell, the arrangement of the slide bar at an end in the mounting chamber is capable of triggering the control switch; one end of the spring is connected to the slide bar and the other end thereof is connected to the mounting shell.

In some embodiments of the disclosure, a chamfer is formed at an end of the slide bar outside the mounting chamber.

In some embodiments of the disclosure, a positioning base is mounted on the door frame, the positioning base includes a positioning groove, and a first opening is formed at an upper end of the positioning groove; and a chamfer is formed on an inner sidewall of the positioning groove at the first opening.

In some embodiments of the disclosure, a second opening is formed on an end face of the positioning groove facing the pressing module, and a chamfer is formed on an outer sidewall of the positioning groove at the second opening.

In some embodiments of the disclosure, the detection assembly further includes a warning light, which is mounted in a first through hole formed in an upper end of the mounting chamber and electrically connected to the control panel.

In some embodiments of the disclosure, the detection assembly further includes a buzzer electrically connected to the control panel, and an inner sidewall of the mounting chamber is formed with a second through hole corresponding to the buzzer.

In some embodiments of the disclosure, the detection assembly further includes a wireless communication module, the wireless communication module is mounted in the mounting chamber, and the wireless communication module is electrically connected to the control panel.

In some embodiments of the disclosure, the mounting chamber is located in a lower portion of the mounting shell, a switch is arranged on a sidewall of the mounting chamber, an upper portion of the mounting shell is divided into a battery compartment and a wiring compartment by a spacer that is arranged vertically, the battery compartment is opened or closed by a compartment door, and the first through hole is located in an upper portion of the wiring compartment.

Any one of the above technical solutions has at least the following beneficial technical effects: the pressing module is driven when the door body is switched between the open state and the closed state, and thus the control switch is triggered. The control panel can determine whether the door body is in the open state or the closed state according to the state of the control switch. The purpose of knowing the opening/closing of the door body is realized. The caregiver may be aware of the opening/closing of the door body by the infant or pet and deal with this situation in time.

### BRIEF DESCRIPTION OF THE DRAWINGS

The disclosure will be further described below with reference to embodiments in combination with the accompanying drawings.

FIG. 1 is a schematic view of a door body in a closed state according to an embodiment of the disclosure;

FIG. 2 is a schematic view of the door body in an open state according to an embodiment of the disclosure;

FIG. 3 is a partially enlarged view of part A of FIG. 2;

FIG. 4 is a first schematic view of a detection assembly according to an embodiment of the disclosure; and

FIG. 5 is a second schematic view of the detection assembly according to an embodiment of the disclosure.

### LIST OF REFERENCE NUMERALS

10: door frame; 11: door body; 12: detection assembly; 13: control panel; 14: pressing module; 15: locking assembly; 16: mounting shell; 17: mounting chamber; 18: slot; 19: positioning base; 20: positioning groove; 21: first opening; 22: second opening; 23: warning light; 24: first through hole; 25: second through hole; 26: power switch; 27: spacer; 28: battery compartment; and 29: compartment door.

### DETAILED DESCRIPTION OF THE EMBODIMENTS

This section will describe the specific embodiments of the disclosure in detail. The preferred embodiments of the disclosure are shown in the drawings. The drawings are provided to supplement, with graphics, the description of the text part of the specification, so that people can intuitively and visually understand each technical feature and overall technical solution of the disclosure, and should not be understood as any limitations to the protection scope of the disclosure.

In the description of the disclosure, it should be understood that orientations or locations indicated by terms “upper”, “low”, “front”, “rear”, “left” and “right” are the orientations or locations illustrated on the basis of the accompanying drawings, merely used for conveniently describing the disclosure and simplifying the description and not intended to indicate or imply that the device or element indicated must have the specific orientations or must be constructed and operated in the specific orientations, thus shall not be interpreted as any limitations to the disclosure.

In the description of the disclosure, “several” means “one or more”; “a plurality of means” “more than two”; “greater than”, “less than”, “exceeding” or the like should be considered as excluding the number; and “above”, “below”, “within” or the like should be considered as including the number. Terms such as “first” and “second”, if mentioned, are used only for the purpose of distinguishing the technical features, and should not be understood as indicating or implying relative importance or implicitly indicating the number of the indicated technical features or impliedly indicating the order of the indicated technical features.

In the description of the disclosure, unless otherwise clearly defined, terms such as “arrange”, “mount”, “connect” should be understood in a broad sense, and those skilled in the art can reasonably determine the specific meaning of the above terms in the disclosure in conjunction with the specific content of the technical solution.

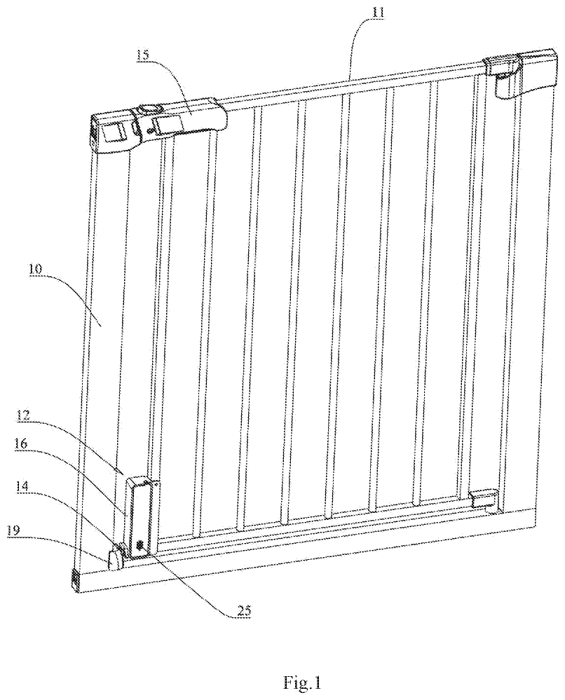

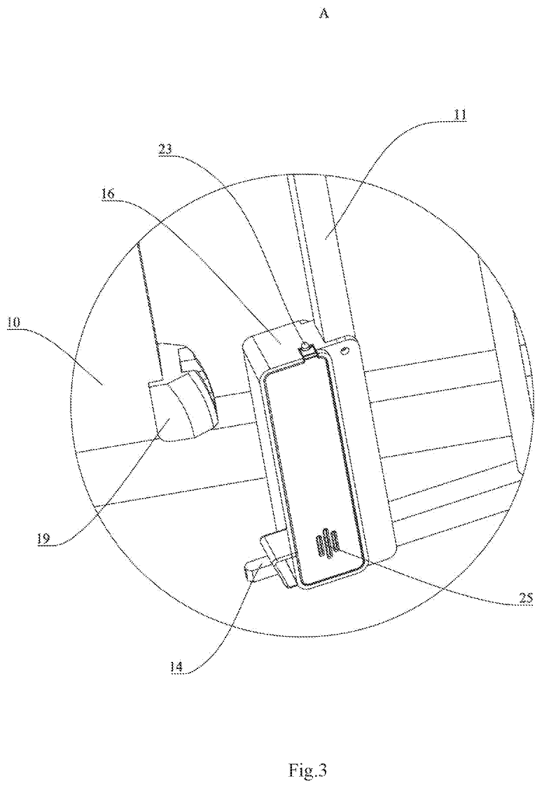

With reference to FIGS. 1-5, there is provided a playpen door according to an embodiment of the disclosure, including a door frame 10, a door body 11 and a detection assembly 12. The door body 11 is movably mounted on the door frame 10. The door body 11 has an open state and a closed state. The detection assembly 12 is mounted on the door body 11. The detection assembly 12 includes a control panel 13, a control switch and a pressing module 14. The control switch is arranged on the control panel 13. The pressing module 14 is configured to be movable with respect to the control switch to trigger the control switch. The pressing module 14 is driven to move with respect to the control switch when the door body 11 is switched between the open state and the closed state. In this embodiment, the door body 11 is hinged to the door frame 10. A locking assembly 15 is arranged between the door body 11 and the door frame 10. The locking assembly 15 may be a locking assembly in the prior art and will not be repeated here. The detection assembly 12 is mounted away from a position where the door body 11 is hinged to the door frame 10. The control switch may be a light touch switch that is highly responsive. In this embodiment, the pressing module 14 is driven when the door body 11 is switched between the open state and the closed state, and thus the control switch is triggered. The control panel 13 can determine whether the door body 11 is in the open state or in the closed state according to the state of the control switch. Triggering the control switch is implemented by a contact-type mechanical structure which is highly stable in operation and extremely high in accuracy, and is more accurate than contactless detection. In this embodiment, the purpose of knowing the opening/closing of the door body 11 is realized. The caregiver may be aware of the opening/closing of the door body 11 by the infant or pet and deal with this situation in time.

Of course, it may be understood by those skilled in the art that the control switch may have other implementations. For example, the control switch may be a microswitch or the like. The door body 11 may also be movably mounted on the door frame 10 in other structures. For example, the door body 11 may be movably mounted on the door frame 10 in a sliding manner, and in this case, the door body 11 may also be opened/closed. In addition, the detection assembly 12 may be mounted on the door frame 10 to realize the same technical effects.

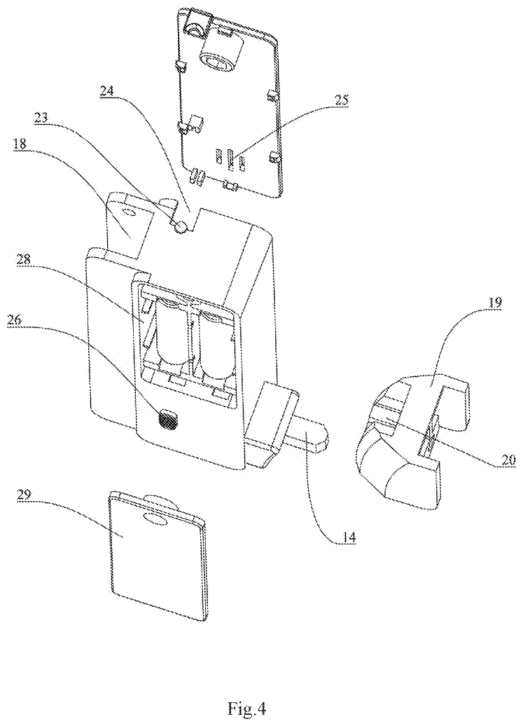

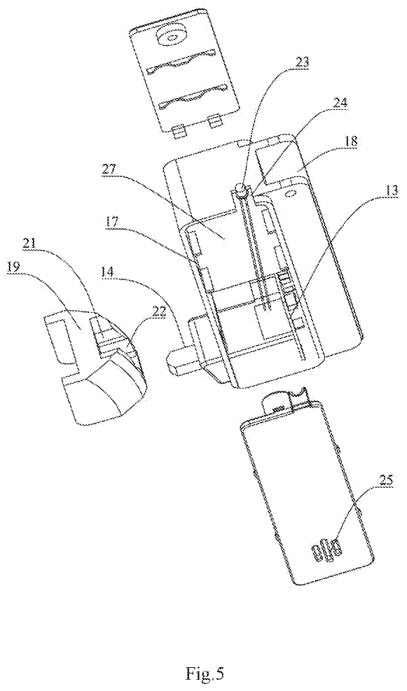

As shown in FIGS. 4 and 5, in some embodiments of the disclosure, the detection assembly 12 includes a mounting shell 16. The mounting shell 16 has a mounting chamber 17. The mounting shell 16 is mounted on the door body 11. The control panel 13 is located in the mounting chamber 17. The pressing module 14 is slidably mounted in the mounting shell 16. One end of the pressing module 14 is located in the mounting chamber 17 and the other end thereof is located outside the mounting chamber 17. A slot 18 is formed on an outer sidewall of the mounting shell 16. The slot 18 is fitted with vertical bars of the door body 11. The slot 18 is fixed to the door body 11 by screws. An end of the pressing module 14 outside the mounting shell 16 is fitted with the door frame 10. When the door body 11 is in the closed state, the door frame 10 can push the control switch towards the inside of the mounting shell 16, and the pressing module 14 is kept in contact with the light touch switch. In this case, the control panel 13 determines that the door body 11 is in the closed state. When the door body 11 is in the open state, due to the lack of the restriction of the door frame 10, the pressing module 14 slides out and does not push against the light touch switch any more. In this case, the control panel 13 determines that the door body 11 is in the open state.

As shown in FIGS. 4 and 5, in some embodiments of the disclosure, the pressing module includes a slide bar and a spring. The slide bar is slidably mounted in the mounting shell 16, and an end of the slide bar in the mounting chamber 17 can trigger the control switch. One end of the spring is connected to the slide bar and the other end thereof is connected to the mounting shell 16. Since the slide bar is not restricted by the door frame 10 when the door body 11 moves out of the closed state, the slide bar slides toward a direction away from the door body 11 and does not push against the light touch switch any more under the action of the spring.

As shown in FIGS. 4 and 5, to facilitate the fitting of the slide bar with the door frame 10, in some embodiments of the disclosure, an end of the slide bar outside the mounting chamber 16 is provided with a chamfer which facilitate the entry of slide bar into the door frame 10, so that the door body 11 moves smoothly from the open state to the closed state without jamming.

As shown in FIGS. 4 and 5, to facilitate the fitting with the slide bar, in some embodiments of the disclosure, a positioning base 19 is mounted on the door frame 10, the positioning base 19 includes a positioning groove 20, and a first opening 21 is formed at an upper end of the positioning groove 20; and a chamfer is formed on both of an inner sidewall and a bottom surface of the positioning groove 20 at the first opening 21. The positioning groove 20 is used to fit with the slide bar. In this embodiment, when it is needed to open the door body 11, it is necessary to lift the door body 11 up and then rotate it. Therefore, the first opening 21 is formed at the upper end of the positioning groove 20 for the entering of the slide bar into the positioning groove 20 from the upper end of the positioning groove 20. The formation of the chamfer at the first opening 21 is convenient for the slide bar to smoothly slide into the positioning groove 20, thereby reducing the possibility of jamming during its sliding.

As shown in FIGS. 4 and 5, in some embodiments of the disclosure, a second opening 22 is formed on an end face of the positioning groove 20 facing the pressing module 14, and a chamfer is formed on an outer sidewall of the positioning groove at the second opening 22. The second opening 22 can provide an avoiding space for the slide bar.

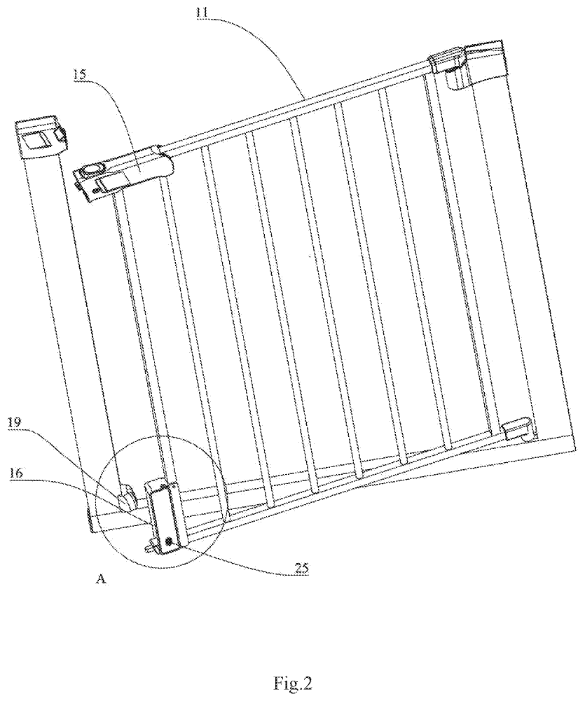

As shown in FIGS. 1 and 2, when the door body 11 is opened, information indicative of the opening of the door body 11 needs to be transmitted to the caregiver in time. For this reason, in some embodiments of the disclosure, the detection assembly 12 further includes a warning light 23. A first through hole 24 is formed in an upper end of the mounting chamber 17. The warning light 23 is mounted in the first through hole 24 and electrically connected to the control panel 13. The exposure of the warning light 23 from the mounting chamber 17 is convenient for the caregiver to check in time. The warning light 23 may be implemented by a flickering red light. When the door body 11 is opened, the control panel 13 sends a signal to control the warning light 23 to turn on. The warning light 23 is connected to a power supply. The power supply may be a dry battery or button battery.

As shown in FIGS. 1 and 2, when the door body 11 is opened, information indicative of the opening of the door body 11 needs to be transmitted to the caregiver in time. For this reason, in some embodiments of the disclosure, the detection assembly 12 further includes a buzzer electrically connected to the control panel 13, and an inner sidewall of the mounting chamber 17 is formed with a second through hole 25 corresponding to the buzzer. When the door body 11 is opened, the control panel 13 sends a signal to control the buzzer to turn on. The buzzer is connected to a power supply which may be a dry battery or button battery. The second through hole 25 can reduce the attenuation of sound made by the buzzer during the propagation, thereby avoiding waste of energy.

The buzzer may be replaced by a speaker in which sound may be pre-recorded. For example, the warning of the caregiver may be pre-recorded. When the door body 11 is opened, the speaker plays the warning, by which the infant or pet may go back to the playpen in time, thereby realizing the infant/pet-caring effect.

When the door body 11 is opened, information indicative of the opening of the door body 11 needs to be transmitted to the caregiver in time. For this reason, in some embodiments of the disclosure, the detection assembly 12 further includes a wireless communication module. The wireless communication module is mounted in the mounting chamber 17 and electrically connected to the control panel 13. The wireless communication module can communicate with the caregiver's mobile phone. When the door body 11 is opened, the control panel 13 sends a signal to control the wireless communication module to operate. The wireless communication module sends a signal to the caregiver's mobile phone, to remind the caregiver of the opening of the door body 11. The wireless communication module is connected to a power supply which may be a dry battery or button battery. The use of the wireless communication module can greatly increase the range of application of this embodiment, so that the caregiver can go away from the playpen and can know the state of the playpen door in time.

It may be understood by those skilled in the art that the warning light 23, the buzzer, the speaker, and the wireless communication module may all exist in an embodiment of the disclosure, and may also exist alone or in a combination of any two thereof or in a combination of any three thereof, depending upon the actual use environment. For example, if the use environment is noisy, the buzzer and speaker may be omitted; and if the use environment is quite bright, the warning light 23 may be omitted; and so forth.

As shown in FIGS. 4 and 5, in some embodiments of the disclosure, the mounting chamber 17 is located in a lower portion of the mounting shell 16. A power switch 26 is arranged on the sidewall of the mounting chamber 17. An upper portion of the mounting shell 16 is divided into a battery compartment 28 and a wiring compartment by a spacer 27 that is arranged vertically. The battery compartment 28 is opened or closed by a compartment door 29. The first through hole 24 is located in an upper portion of the wiring compartment. The battery compartment 28 is provided to receive a battery which may be a dry battery or button battery or rechargeable battery or the like. The power switch 26 is configured to control the battery to supply power. The whole detection assembly 12 stops operating when the power switch 26 is opened. It is necessary to close the power switch 26 when monitoring is required. The spacer 27 can reasonably divide and thus make full use of the space in the mounting chamber 17, thereby reducing the volume of the first mounting shell 16. The formation of the first through hole 24 in the upper portion facilitates the caregiver to check the warning light 23. The overall structure design is simple, ingenious and highly practical.

The embodiments of the disclosure have been described in detail above with reference to the drawings. However, the disclosure is not limited to the above-mentioned embodiments, and within knowledge of a person of ordinary skill in the art, various changes may be made without departing from the principle of the disclosure.

1. A playpen door, comprising:
a door frame;
a door body movably mounted on the door frame and having an open state and a closed state; and
a detection assembly mounted on the door frame or the door body, wherein the detection assembly comprises a control panel, a control switch and a pressing module, the control switch is arranged on the control panel, the pressing module is configured to be movable with respect to the control switch to trigger the control switch, and the pressing module is driven to move with respect to the control switch when the door body is switched between the open state and the closed state.

2. The playpen door according to claim 1, wherein the detection assembly comprises a mounting shell having a mounting chamber; the mounting shell is mounted on the door body, the control panel is located in the mounting chamber, the pressing module is slidably mounted in the mounting shell, and one end of the pressing module is located in the mounting chamber and the other end of the pressing module is located outside the mounting chamber.

3. The playpen door according to claim 2, wherein the pressing module comprises a slide bar and a spring, the slide bar is slidably mounted in the mounting shell, an end of the slide bar in the mounting chamber is capable of triggering the control switch; and one end of the spring is connected to the slide bar and the other end of the spring is connected to the mounting shell.

4. The playpen door according to claim 3, wherein a chamfer is formed at an end of the slide bar outside the mounting chamber.

5. The playpen door according to claim 4, wherein a positioning base is mounted on the door frame, the positioning base comprises a positioning groove, and a first opening is formed at an upper end of the positioning groove; and a chamfer is formed on an inner sidewall of the positioning groove at the first opening.

6. The playpen door according to claim 5, wherein a second opening is formed on an end face of the positioning groove facing the pressing module, and a chamfer is formed on an outer sidewall of the positioning groove at the second opening.

7. The playpen door according to claim 2, wherein the detection assembly further comprises a warning light, which is mounted in a first through hole formed in an upper end of the mounting chamber and electrically connected to the control panel.

8. The playpen door according to claim 2, wherein the detection assembly further comprises a buzzer electrically connected to the control panel, and an inner sidewall of the mounting chamber is formed with a second through hole corresponding to the buzzer.

9. The playpen door according to claim 2, wherein the detection assembly further comprises a wireless communication module which is mounted in the mounting chamber and electrically connected to the control panel.

10. The playpen door according to claim 7, wherein the mounting chamber is located in a lower portion of the mounting shell, a switch is arranged on a sidewall of the mounting chamber, an upper portion of the mounting shell is divided into a battery compartment and a wiring compartment by a spacer that is arranged vertically, the battery compartment is opened or closed by a compartment door, and the first through hole is located in an upper portion of the wiring compartment.
